(19) United States
(12) Patent Application Publication
(10) Pub. No.: US 2012/0218393 A1
(43) Pub. Date: Aug. 30, 2012

(54) Generating 3D multi-view interweaved image(s) from stereoscopic pairs

(75) Inventors: Philippe Fortin, Montreal (CA); Jean-Louis Bertrand, Montreal (CA)

(73) Assignee: BERFORT MANAGEMENT INC., Laval (CA)

(21) Appl. No.: 13/044,184

(22) Filed: Mar. 9, 2011

Related U.S. Application Data
(60) Provisional application No. 61/311,889, filed on Mar. 9, 2010.

(51) Int. Cl. H04N 13/04

(52) U.S. Cl. 348/59; 348/E13.026

(57) ABSTRACT

An automatic method for producing 3D multi-view interweaved image(s) from a stereoscopic image pair source to be displayed via an auto-multiscopic display. The technique is optimized to allow its use as part of a real-time 3D video handling system. Preferably, the 3D interweaved image(s) are generated from a stereo pair where partial disparity is calculated between the pixels of the stereo images. The partial disparity information is then used at a sub-pixel level to produce a series of target (intermediary) views for the sub-pixel components at each image position (x, y). Then, these target views are used to generate a desired number of views resulting in glass-free 3D via an auto-multiscopic display.

### CROSS-REFERENCE TO RELATED APPLICATION

This application is based on and claims priority from Ser. No. 61/311,889, filed Mar. 9, 2010.

### COPYRIGHT STATEMENT

This application includes subject matter protected by copyright. All rights are reserved.

### BACKGROUND

1. Technical Field

This disclosure relates generally to auto-stereoscopic 3D display technologies and methods.

2. Background of the Related Art

Stereopsis is the process in visual perception leading to the sensation of depth from two slightly different projections of the world onto the retina of each eye. The differences in the two retinal images are referred to as binocular disparity.

Auto-multiscopy is a method of displaying three-dimensional (3D) images that can be viewed without the use of special headgear or glasses by the viewer. This display method produces depth perception in the viewer, even though the image is produced by a flat device. Several technologies exist for auto-multiscopic 3D displays, such as a flat-panel solution that use lenticular lenses. If the viewer positions his or her head in certain viewing positions, he or she will perceive a different image with each eye, thus providing a stereo image.

### BRIEF SUMMARY

This disclosure provides an automatic method for producing 3D multi-view interweaved image(s) from a stereoscopic image pair source to be displayed via an auto-multiscopic display. The technique is optimized to allow its use as part of a real-time 3D video handling system.

Preferably, the 3D interweaved image(s) are generated from a stereo pair where partial disparity is calculated between the pixels of the stereo images. The partial disparity information is then used at a sub-pixel level to produce a series of target (intermediary) views for the sub-pixel components at each image position (x, y). Then, these target views are used to generate a desired number of views resulting in glass-free 3D via an auto-multiscopic display. The technique more efficiently preserves the resolution of the High-Definition (HD) video content (e.g., 1080p or higher) than what is currently available from the prior art.

The technique may be used with or in conjunction with auto-multiscopic 3D displays, such as a flat panel display using a lenticular lens.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 illustrates a high level view of an overall image capture, processing and display technique according to an embodiment of this disclosure;

FIG. 2 illustrates a representative system to generate the 3D multiple-view interweaved images from a stereoscopic pair;

FIG. 3 illustrates how partial disparity information is obtained according to an embodiment of the disclosed method;

FIG. 4 illustrates representative code that when implemented (e.g., as a series of computer program instructions in a processor) provides a partial disparity analyzer according to one embodiment;

FIG. 5 illustrates the manner in which points retrieved by the disparity analyser are grouped to form a list of line segment pairs according to this disclosure;

FIG. 6 illustrates how, during the view generation, distortion is balanced between the leftmost and the rightmost image based on percentages that reflect the relative position of a target view;

FIG. 7 illustrates a pair of representative pixel patches generated by the view generator;

FIG. 8 illustrates a relationship between a representative left image and a representative right image;

FIG. 9 describes a representative weighing formula for use in a line transformation process;

FIG. 10 is a representative implementation of the “transformation of all of the pair lines” process;

FIG. 11 illustrates a relationship between the representative left image and the representative right image when the weighted averaging technique is implemented;

FIG. 12 illustrates a set of line segments and how a target view is specified using these segments;

FIG. 13 provides additional details of how two lines are interpolated to represent a target view;

FIG. 14 illustrates an example of a metamorphosis process applied to a pair of views;

FIG. 15 illustrates the nine (9) views combined in a single image according to the disclosed processing;

FIG. 16 illustrates how a 3D conversion box that implements the above-described techniques may be used within a video display system;

FIG. 17 illustrates an alternative embodiment of the video display system;

FIG. 18 illustrates a representative digital signal processor (DSP)/FPGA for use in the 3D conversion box; and

FIG. 19 illustrates a representative motherboard configuration for the 3D conversion box.

### DETAILED DESCRIPTION OF AN EMBODIMENT

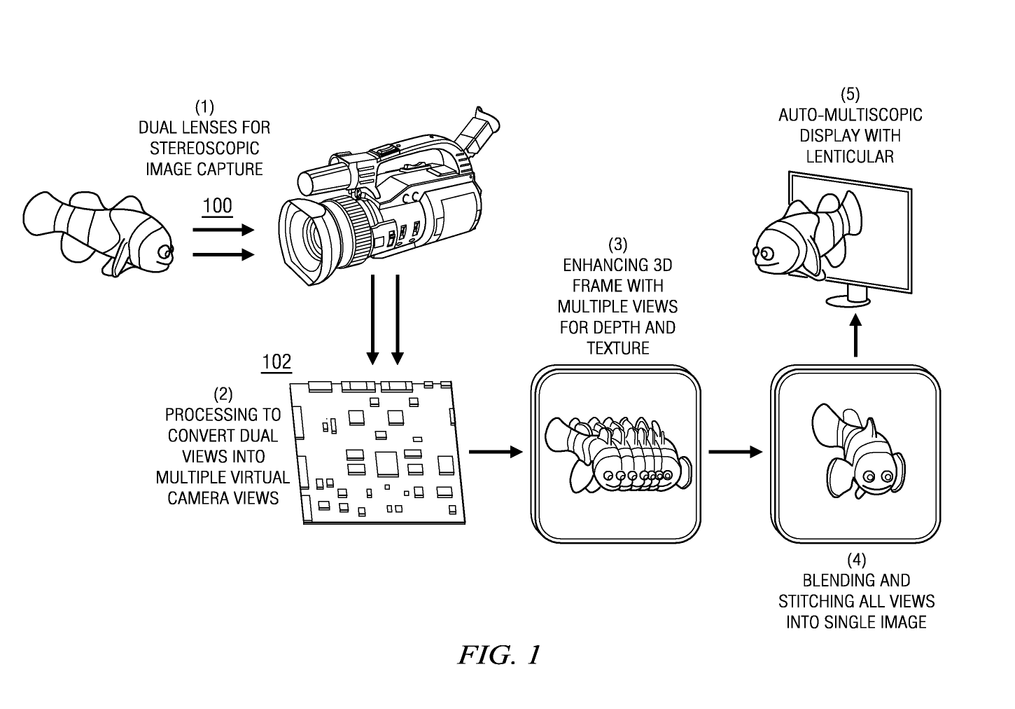

FIG. 1 illustrates a high level view of an overall image capture, processing and display technique according to an embodiment of this disclosure. Using a 3D camera 100 (step 1), an operator captures original content in stereo. A High-Definition (HD) 3D processor, represented by circuitry 102, associated with the camera 100 converts (step 2) the original stereo image into HD 3D content; preferably, this conversion is accomplished by generating a given number (e.g., 9) individual views (step 3) that are then stitched together (step 4) into a single HD image. The resulting HD 3D content is then stored on an integrated data storage device (e.g., a solid state drive, or SSD), or in an external storage area network (SAN), or otherwise in-memory. The HD 3D content can also be displayed (step 5) in real-time on an auto-multiscopic display device 104 to allow visualization of the capture content.

Image capture using a camera (such as illustrated in FIG. 1) is not required. In an alternative, the video content is made available to (received at) the system in a suitable format (e.g., as HD content). Whether the content is captured live or provided on-demand (e.g., from a data store), preferably the following technique is used to generate 3D multiple-view interweaved images from a stereoscopic pair.

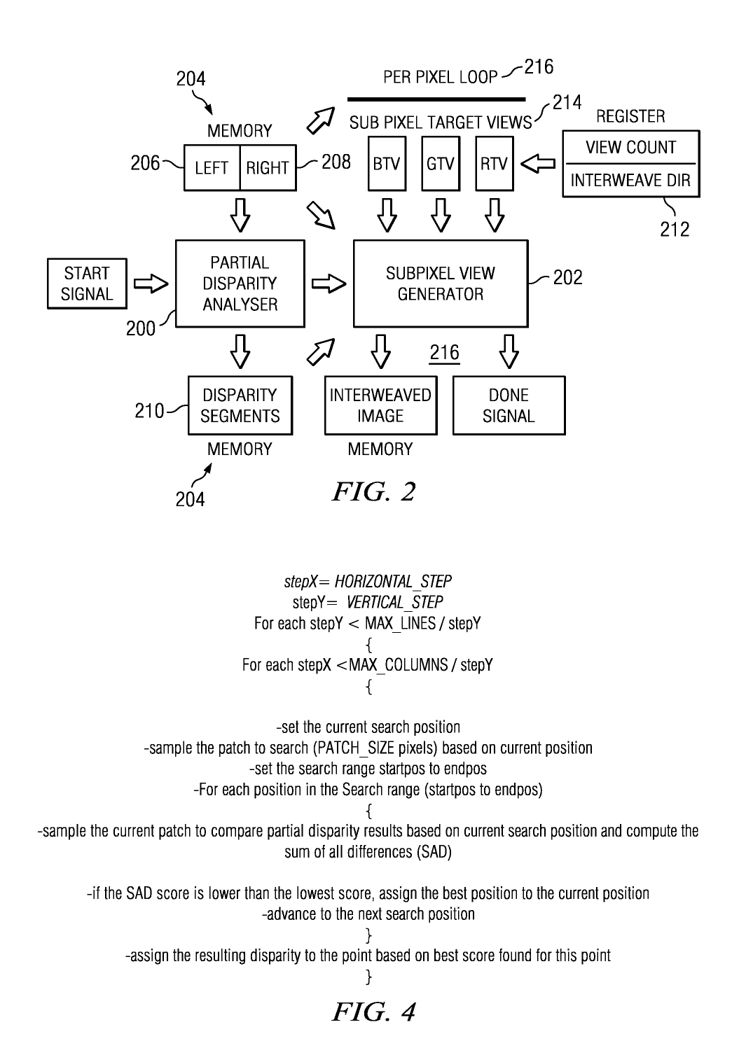

FIG. 2 illustrates a representative system to generate the 3D multiple-view interweaved images from a stereoscopic pair. In this embodiment, the system is implemented in a field-programmable gate array (FPGA), although this is not a limitation. The system components may be implemented in any processing unit (e.g., a CPU, a GPU, or combination thereof) suitably programmed with computer software.

As illustrated in FIG. 2, the main components of the system are a partial disparity analyzer 200, and a sub-pixel view generator (sometimes referred to as an “interweaver”) 202. Each of the components is described in detail below. As noted, in a representative embodiment, the system receives as input a video content signal, such as a series of High Definition (HD) frames. This video content is received in a frame buffer (not shown) stored in memory 204 as a pair of images (left 206 and right 208). Generally, the partial disparity analyzer 200 processes information from a stereo image pair (oriented left and right, top and bottom, or more generally “first” and “second”) and generates disparity list segment pairs 210 stored in memory 204. The sub-pixel view generator 202 takes this information, together with a stereoscopic image pair as a reference target for a first (typically leftmost 206) view and last (typically rightmost 208) view, and calculates an appropriate view position for each sub-pixel of the image according to the settings defined in a register 212 for the number of desired views and the direction (or slant) of the lenticular lens. For each intermediate view generated (and inserted) between the leftmost and rightmost views, the view generator 202 compensates for distortion as a function of a position of the intermediate view. Preferably, there are at least nine (9) intermediate views, although this is not a limitation.

More specifically, the partial disparity analyser process 200 is triggered via a start signal (step 1) from an external process or processor (not shown). Upon receiving the start signal, the partial disparity analyser 200 reads from memory 204 the content of the left 206 and right 208 images of the stereo pair; it then calculates the disparity segments for each specific patch of X lines and Y columns (as described in more detail below). The partial disparity analyser 200 fetches the required number of pixels for each of the X lines and Y columns patch being analyzed from the left 206 and right 208 images. The resulting disparity segments 210 are stored in memory 204 for later use by the sub-pixel view generator 202.

The sub-pixel view generator 202 is fed with sub-pixel target views 214 for Blue (Btv), Green (Gtv) and Red (Rtv) sub-components based on the processing performed by a per pixel loop 216; loop 216 is responsible for selecting the proper target views based on the disparity segments 210 determined by the partial disparity analyzer 200. The sub-pixel view generator 202 uses the sub-pixel target views 214, the left 206 and right 208 images and the disparity segments 210 to interweave each sub-pixel into the proper target view, which results in an interweaved image 216 that is stored in memory 204. After processing every pixel of the left 206 and right 208 images stored in memory 204, the sub-pixel view generator 202 sets a done signal to notify the external process or processor that the interweaved image 216 is ready to be stored on a media storage and/or transferred to a 3D display.

The following provides additional details regarding the partial disparity analyzer, and the sub-pixel view generator components/functions.

### Partial Disparity Analyzer

Stereo matching by computing correlation or sum of squared differences is a known technique. Disparity computation is commonly done using digital stereo images, but only on a pixel basis. According to the partial disparity analysis of this disclosure, partial disparity information is retrieved (or obtained) preferably by taking a “patch” (a group of N consecutive sub-pixels) every (StepX, StepY) pixels in a first (e.g. left) image, and then finding a best corresponding patch at each valid disparity between a searching range (position−StepX to position+StepX) in a second (e.g., right) image. For example, for a disparity of 0, the two patches are at the exact same location in both images. For a disparity of 1, the patch in the right image is moved one (1) pixel to the left. The absolute difference is then computed for corresponding sub-pixels in each patch. These absolute differences are then summed to compute a final SAD (“sum of absolute difference”) score. After this SAD score has been computed for all valid disparities in the search range, preferably the disparity that produces the lowest SAD score is determined to be the disparity at that location in the right image.

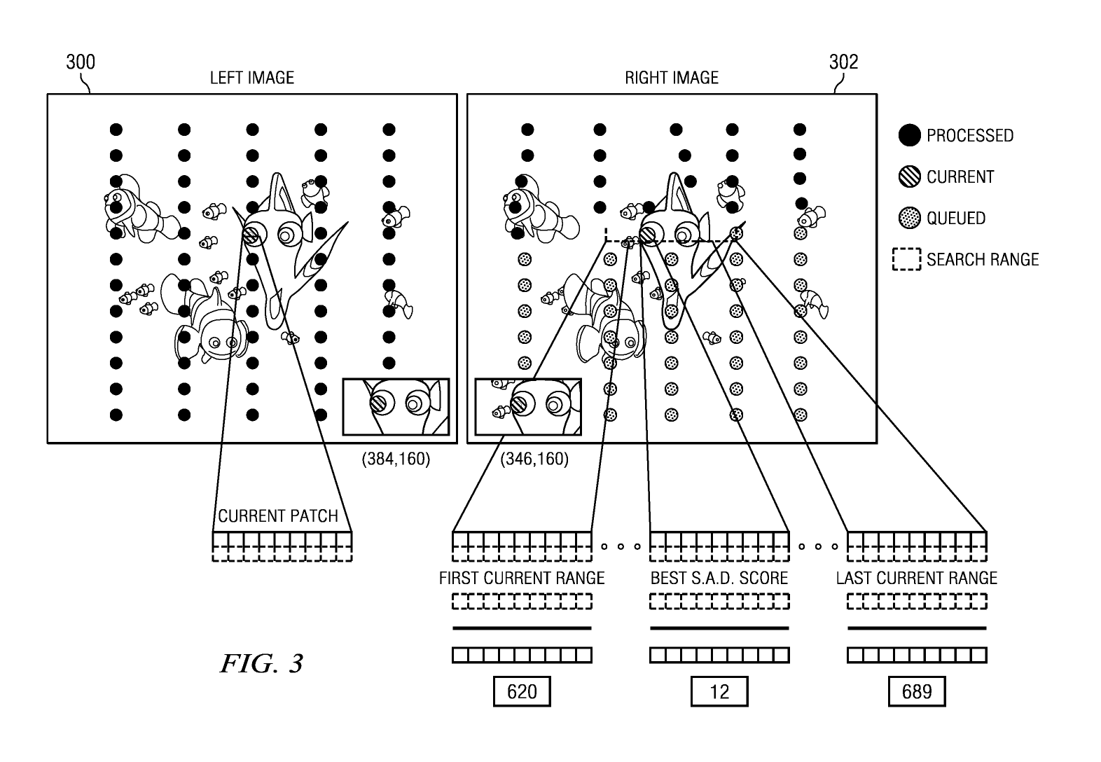

FIG. 3 shows a left image 300, and a corresponding right image 302. This drawing also illustrates how to retrieve (obtain) the disparity in right image 302 for a given point, e.g., point #23 at position (384,160), using a step for X value of 128 pixels and a step for Y of 32 pixels (or a patch of 128 pixels by 32 pixels). For the patch fitting the pixel coordinates in the left image, the “sum of absolute difference” (SAD) is calculated against every pixel of the patch in the right image. Preferably, the pixel with the lowest (best) SAD score is kept for the remainder of the process. Preferably, and as illustrated in FIG. 4, and according to this disclosure, the disparity coordinates are grouped to form a number of (e.g., two) lists of simple line segments where the origin of the segment is set to the coordinates of the pixel in the left image (x1, y1) and the destination of the segment is set to the coordinates of the pixel in the right image (x2, y2) with the lowest SAD score for the origin pixel. Example: left image (64, 64) (64, 128)—right image (58, 64) (63, 128). These two lists are then combined into one final list composed of segment line pairs, such as: (64, 64, 64, 128, 58, 64, 63 and 128). This final segment line pair list is then passed to the sub-pixel view generator (the interweaver) to compute the final interweaved output image.

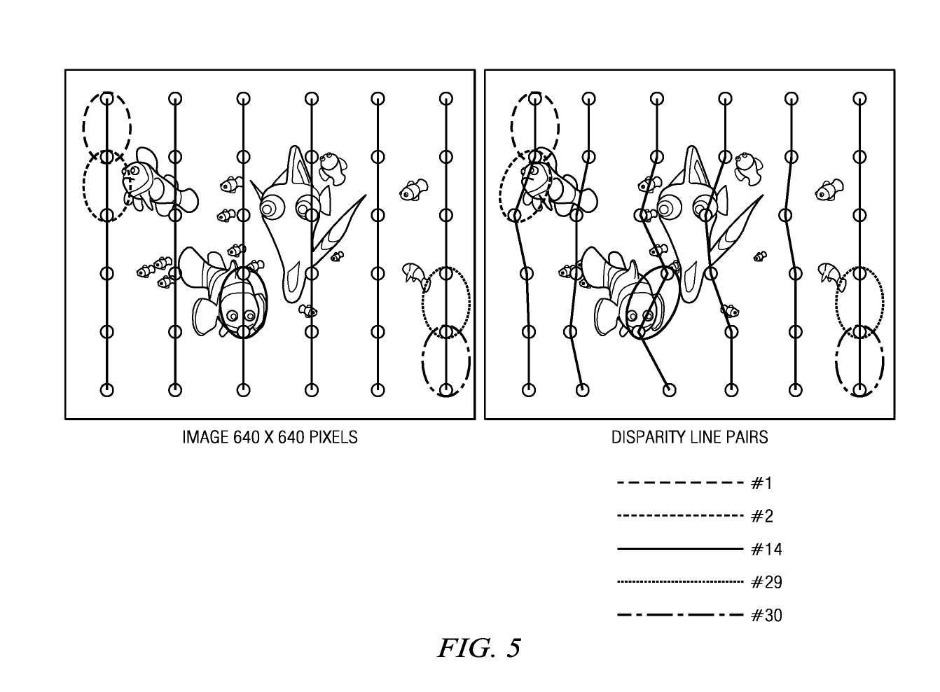

FIG. 5 illustrates the manner in which points retrieved by the disparity analyzer are grouped to form a list of line segment pairs. While the segments coordinates in the left image show no disparity, the segments in the right image are used to determine the amount of disparity detected and the direction of the said disparity. In this example, points 1 and 7 form a first line, points 7 and 13 form a second line, and so on, for all points. Of course, this example is merely representative, and it should not be taken as limiting.

### View Generator/Interweaver

As the image view generator proceeds, the left image begins to distort and fades out, while the right image is already distorted toward the left and faded in. Generally, the goal of the view generator/interweaver component is to smooth out the distortion between the left and right images of a stereoscopic pair. For each intermediate view generated (and inserted) between the leftmost and rightmost views, preferably the distortion is compensated by a factor based on a position of the generated target view relative to the leftmost and rightmost images. Therefore, at the beginning of the process, the first generated views (images) are much like the left source image, while the middle generated view (image) is a blend of the left source image distorted halfway toward the right view (image) source and the right source image distorted halfway back toward the left one. The last generated images typically are similar to the right source image. More specifically, typically the distortion is balanced between the leftmost and the rightmost image based on percentages that reflect the relative position of the target view, preferably as follows:

Percentage of leftmost view=1−(Target View #)/Total # of Target Views

Percentage of rightmost view=(Target View #)/Total # of Target Views

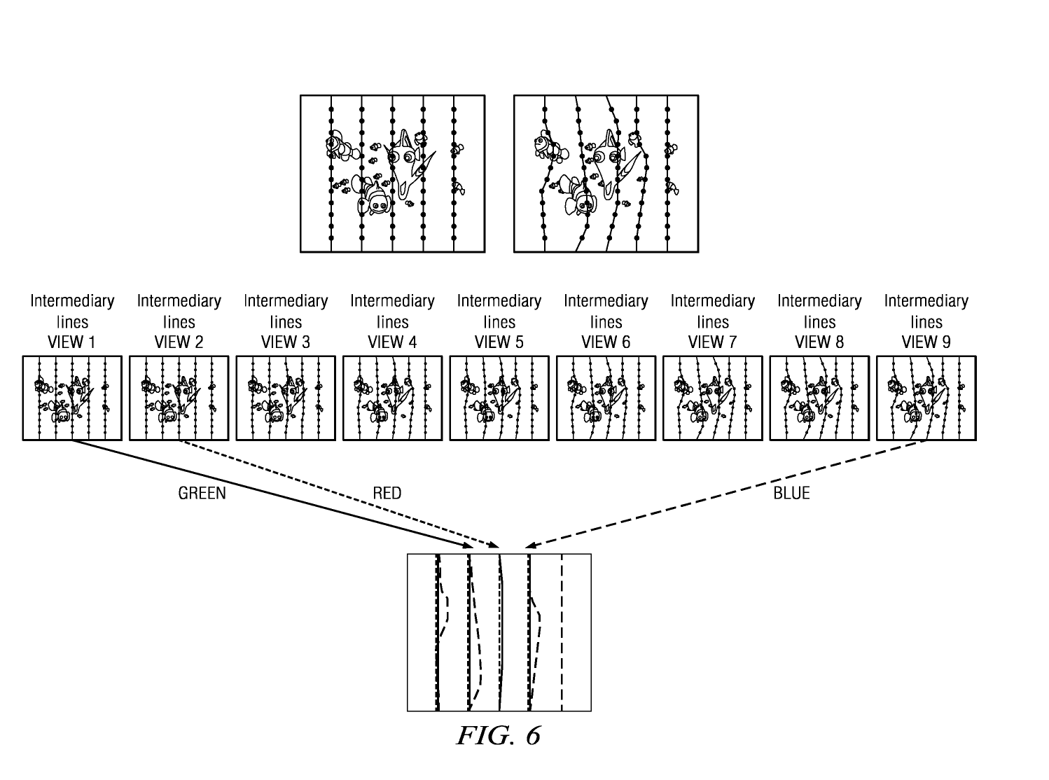

This is illustrated in FIG. 6 with respect to the representative nine (9) views.

FIG. 6 describes the triple list used for sub-pixel sampling at position (x, y). In the above example, the required view for respective components blue, green and red are: 9, 1 and 2, based on the calculated SAD score for the position (x, y) (provided by the partial disparity analyzer). By selecting the value for each sub-component (R, G and B) of the pixel in the target view and by using the “line pairs” technique that relies on the line pairs obtained during the partial disparity analysis phase (see FIG. 6 and the following paragraphs), it is possible to obtain a smooth transition between each target views. This technique is very efficient due to its ability to control the deformation by relative influence to the pixel/lines distance. The approach successfully maintains stereopsis, and it preserves the 3D.

A preferred implementation of the “line pairs” technique is as follows. In particular, preferably the line pairs are relocated by using control points that are explicitly specified. Preferably, the lines are then moved exactly where they are projected. All that is not located on the lines is relatively projected to that position. Preferably, the influence of the differences between lines and of the weight ratio for each distance is further adjusted by additional constant values (described in more detail below). These constants facilitate preserving the quality of the stereopsis. Preferably, all segments of lines are referenced for each pixel and the deformation by influence is global. The sum of iterations for each image/frame to be performed preferably is proportional to the product of the pixel count of the images/frame and the number of line pairs used. Preferably, the number of line pairs is directly linked to the distance between two points of the disparity analyzer. A default number for the width of the patch is 128, although this is not limiting. Using different values influences the performance of the algorithm.

Using a stereoscopic pair as a reference target for the leftmost and rightmost views, along with the calculated partial disparity list segment pair generated by the disparity analyzer module (see FIG. 3), the generator/interweaver then calculates the appropriate view position for each sub-pixel of the final interweaved image to be displayed. The processed interweaved image(s) are generated in accordance to the number of the requested views and the needed interweaving direction of the auto-multiscopic display. Because the number of target views represents the number of sub-pixels used to generate these views, the width (in pixels) of the patch is actually (N/3×N) pixels.

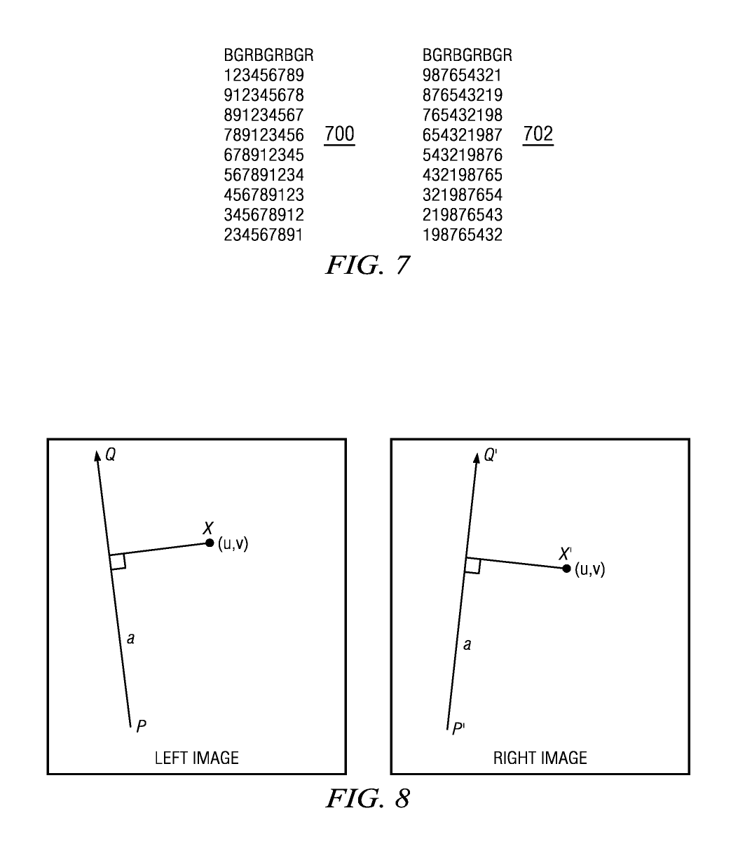

By way of example only, a positive slant for a nine (9) view lens would be represented by the 3×9 pixels patch 700 shown in FIG. 7. A negative slant of a 9 view lens would be represented by the 3×9 pixels patch 702 shown in FIG. 7. Of course, these are merely representative examples.

### Transforming One Pair of Lines

The purpose of a pair of lines is to define, identify and position a mapping from one image to the other (one pair of lines defined relative to the left image and one pair of lines relative to the right image). Lines are specified by pairs of pixel coordinates (PQ), scalars are bold lowercase italics, and primed variables (X′, u′) are values defined relative to the Right image. The term line means a directed line segment. A pair of corresponding lines in the left and right image defines the coordinate mapping from the destination image pixel coordinate X to the left targeted image pixel coordinate X′ such that, for a line PQ in the left image, there is P′Q′ in the right image.

There are two perpendicular vectors with the same length as the input vector; either the left or right one can be used, as long as it is consistently used throughout. The value u is the position along the line, and v is the distance from the line. The value u goes from 0 to 1 as the pixel moves from P to Q, and is less than 0 or greater than 1 outside that range. The value for v is the perpendicular distance in pixels from the line. If there is just one line pair, the transformation of the image proceeds as follows.

For each pixel X in the Left image, find the corresponding u, v, find the X′ in the Right image for that u, v such that: LeftImage(X)=RightImage(X′). FIG. 8 illustrates that X′ is the position to sample in the right image for position X (pixel) in the left image. The X′ position is at a distance v (the distance from the line to the pixel in the left image) from the line P′Q′ and at a proportion u along that line.

Preferably, all pixel coordinates are transformed by either a rotation, translation, and/or a scale. Preferably, the pixels lengthwise of the line in the source image are copied above the line in the targeted image. Because only the u coordinate is normalized by the length of the line, (the v is always the distance in pixels), preferably the target views are scaled along the direction by the ratio of the length of the lines. Preferably, the scaling is applied in the direction of the line.

### Transforming All Pairs of Lines

For all coordinate transformation, preferably a weight value is calculated for each line as follows. For each line pairs, a Xi′ position is calculated. For the left destination image, the difference between the pixel location is the displacement Di=Xi′−X. A weighted average of those displacements is then calculated. The weighted average (value) represents the distance from X to the line.

To determine the X position sampled in the left image, preferably the average value of all displacements is added to the current pixel location X′. As long as the position remains anywhere within the image the weight never goes to zero; the weight assigned to each line is stronger when the pixel is exactly on the line, and weaker when the pixel is further away from it.

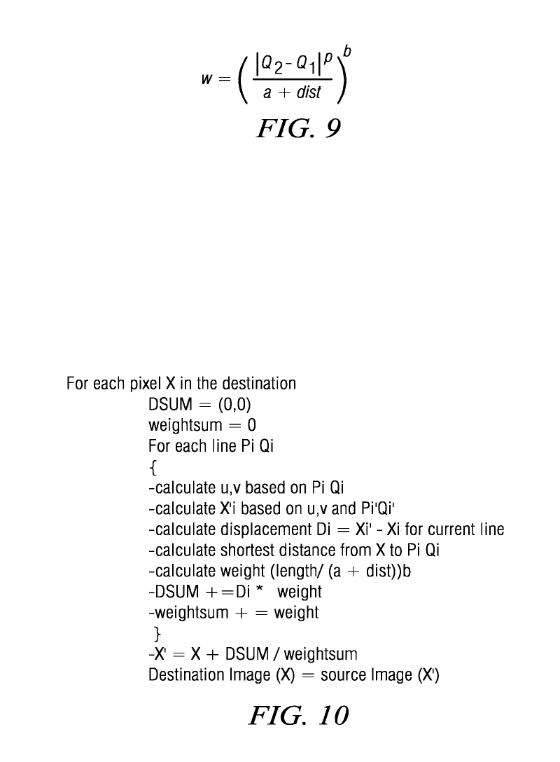

FIG. 9 describes a representative weighing formula, where q2−q1 is the length of a line, dist is the distance from the pixel to the line, and a, b, and p are constants that can be used to change the influences and the behaviour of the lines. If the value of constant “a” is close to zero, and if the distance from the line to the pixel is also zero, the strength is almost infinite. With this value for a, the pixels on the line go where desired. Larger values of constant “a” result in a smoother metamorphosis, but typically with less control and precision. The variable b establishes how the relative strength of the different lines comes to rest with the distance. If it is a large value, then all pixels typically are impacted, but only by the nearest line. If b is zero, then every pixel is affected by all lines equally. If the p value is zero, then all the lines have the same weight. If the p value is one, the longer lines have a greater weight relative to the shorter lines. In one implementation of the weighting system, every line segments have the same length, defined by the Y Step of the disparity analyzer.

A representative implementation of the “transformation of all of the pair lines” process is provided by the code illustrated in FIG. 10.

Because the “lines” are directed line segments, the distance from a line to a point depends on the value of u as follows:

if 0<u<1: the distance is abs (v)

if u<0: the distance is from P to the point

if u>1: the distance is from Q to the point.

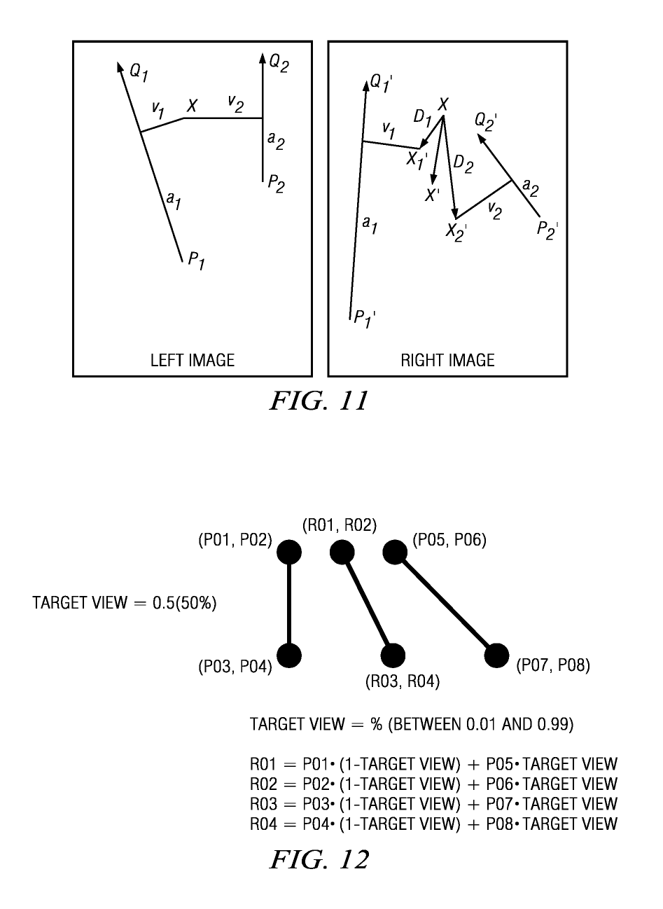

In FIG. 11, X′ is the location to sample the source image for the pixel at position X in the targeted image. Preferably, that location is a weighted average of the two pixel locations X1′ and X2′, processed with the first and second line pair, respectively. The nearer pixels are to a line, the more closely they follow that line motion regardless of the motion of all other lines. Pixels nearer to the lines are moved along with the lines, whereas pixels equally far away from two lines are influenced by both of these lines.

### Interpolating Pixel Sub Component to Desired View

The final mapping of the pixel operation blends the stereo pairs with one another (left and right) based on the relative position of the (intermediate) target views between the leftmost and rightmost views. To achieve this, a corresponding set of lines in the left and in the right images (line pairs) is defined. Each occurring target view is then specified by generating a new set of line segments, and then interpolating these lines from their positions in left to the positions in right. This technique is illustrated in FIG. 12.

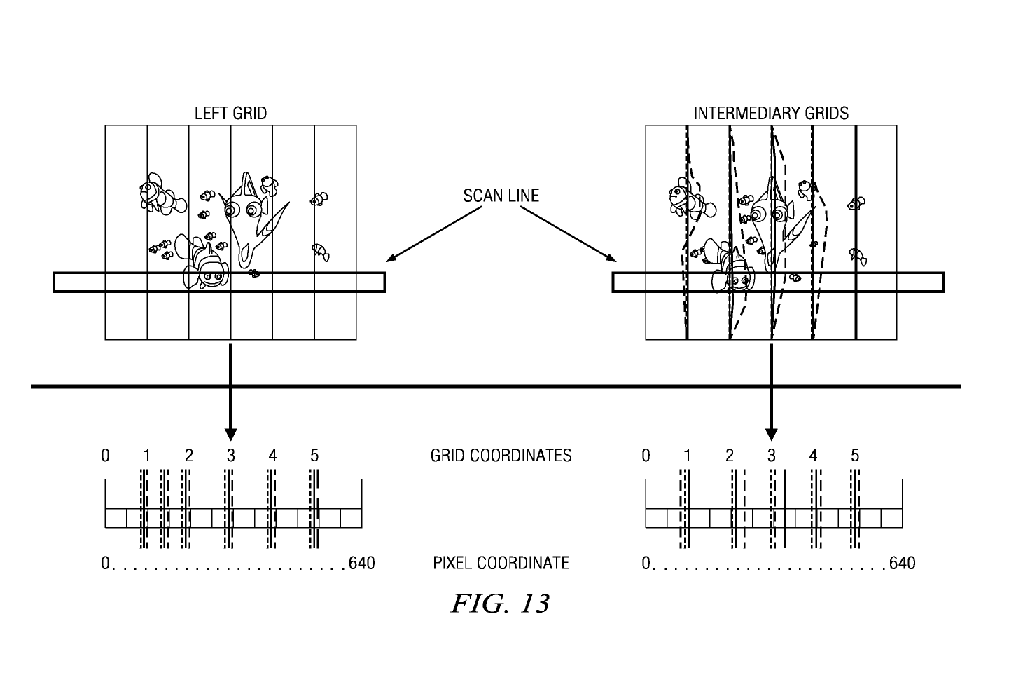

FIG. 13 shows how two lines are interpolated to represent a target view (located at 50%) or view (#5) on a 9 view display. In particular, FIG. 13 illustrates grid coordinates that correspond to the coordinates used during the partial disparity analysis. Because an intermediary grid (for an intermediate target view) may fall between the grid coordinates, the resulting sub-pixels typically fall between the grid coordinates. This is a result of the metamorphosis process that involves the LEFT and RIGHT views as follows:
Lines are defined for both images: LEFT and RIGHT
The mapping between the lines is determined
Depending on the view requirement for a pixel position, preferably three (3) sets of interpolated lines are obtained for each sub-pixel components.
A final pixel value is then obtained as follows:
   The three (3) sets of lines (1 per sub-pixel) for the left image are warped according to the lines corresponding to their respective intermediate views;
   The three (3) sets of lines (1 per sub-pixel) for the right image are warped according to the lines corresponding to their respective intermediate views; and
   The six (6) warped components (BGR sub-pixels for the left and right images) are then combined proportionately depending on how close the frame is with respect to the left and right images.

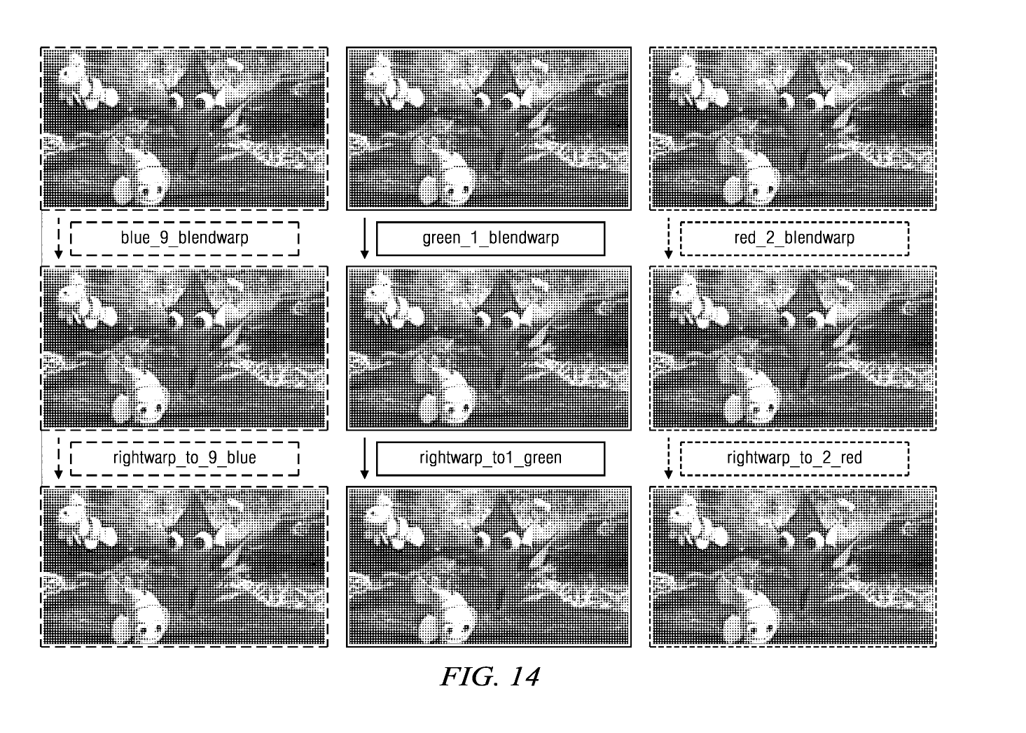

An example of the metamorphosis process for components Blue, Green and Red is shown in FIG. 14. As seen in this example, because the pixels use different views as target for the same pixel position, the process is repeated 3 times (Blue, Green and Red for each pixel component). The final pixel will be a combination of 3 views (1 view per sub-pixel) based on the pixel position (see FIG. 13).

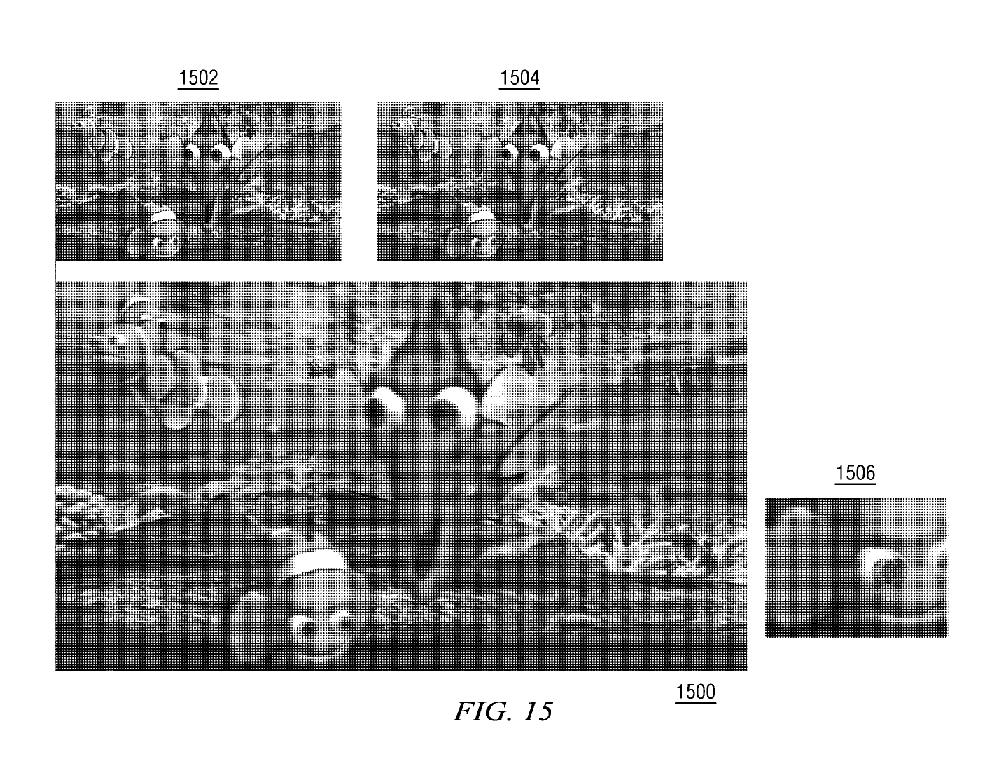

FIG. 15 illustrates the nine (9) views combined in a single image 1500 that is suitable for display via an auto-multiscopic display and viewed in 3D without the need for special viewing polarized glasses or LCD-based shutter glasses. The left source image 1502 and the right source image 1504 used to make the single image also are illustrated, and an extract 1506 from the image 1500 shows the interweaving of the nine (9) views.

The above process bring a significant improvement when compared to simply cross-dissolving the left and right image to obtain an intermediate view. When comparing the result, the partial disparity analysis and the view generator/interweaver processes deliver more realistic results with smoother transition between the intermediate target views and better preserve the High Definition (HD) resolution than what is possible with the prior art.

Thus, according to this disclosure, a computationally-efficient method is described to compute partial disparity information to generate multiple images from a stereoscopic pair in advance of an interweaving process for the display of the multiple images onto an auto-stereoscopic (glass-free) 3D display. The partial disparity information may be calculated as part of a real-time 3D conversion or as an off-line (non-real-time) 3D conversion for auto-stereoscopic display. Preferably, the partial disparity information is calculated at an interval of X horizontal lines and at an interval of Y vertical lines. In particular, in a preferred embodiment, the partial disparity information is derived by calculating a sum of all differences (SAD) inside a range of a specified number of pixels to the left and to the right of a reference position (at which the partial disparity information is desired to be calculated). In operation, a reference value for the SAD calculation is obtained from the left image of the stereo pair and calculated using a range of pixels from the right image, and vice versa. In a preferred embodiment, the “best” SAD score is a lowest calculated SAD value for each position between a leftmost and rightmost range from the reference position. After the calculation, coordinates of the position with the lowest SAD score are then grouped to form a list of line segment pairs that correspond to disparity line pairs. The disparity line pairs identify and position a mapping from a position in the left image and a position of the same element in the right image. The calculated disparity line pairs are used to control a deformation (by relative influence) to the distance between the pixel and the disparity lines. In particular, the lines are specified by a pair of pixel coordinates in the left image and a pair of pixel coordinates in the right image such that, for a disparity line in the left image, there is a corresponding line in the right image. In this approach, a distortion correction is calculated as a percentage of the leftmost view and a percentage of the rightmost view. Preferably, the percentage from the leftmost view is calculated by dividing a view number of a target view by a total number of target views and subtracting the resulting value from one (1), and vice versa from the rightmost view. The calculated percentages are then applied to line pairs to control the deformation between intermediate views by applying a relative influence to the distance between the pixel and the disparity lines.

Thus, the above-described technique determines disparity line pairs that are then used to determine an amount of transformation that needs to be applied to an intermediate view that lies between left and right images of a stereo pair. The amount of transformation may be a rotation, a translation, a scaling, or some combination. Preferably, the amount of transformation for each pixel in a given intermediate view is influenced by a weighted average distance of the pixel and a nearest point on all of the disparity lines (as further adjusted by one or more constant values). Preferably, the distance between a pixel and a disparity line is calculated by tracing a perpendicular line between a disparity line and the pixel. In the described approach, a first constant is used to adjust the weighted average distance to smooth out the transformation. A second constant is used to establish strengths of the different disparity lines relative to the distance of the pixel from the disparity line. A third constant adjusts the influence of each line depending on the length of each disparity line. Preferably, the transformation is applied in the direction of the disparity lines; in the alternative, the transformation is applied from the line toward the pixel. The direction of the transformation is applied uniformly for all pixels and disparity lines in the preferred approach. The transformation results are generated and stored for each intermediate view, or generated and stored only for a final interweaved view.

In the described approach, preferably the final mapping of each pixel in the resulting interweaved image blends the stereo pair (left and right image) with one another based on the relative position of the intermediate target views between the left and right images of the original stereo pair. The final mapping preferably assigns a value to each sub-pixel (RGB, or BGR) based on a most relevant intermediate view for each sub-pixel of the pixel. The most relevant intermediate view for each sub-pixel at the pixel position preferably is determined by a factor based on the position of the generated target view relative to the leftmost and the rightmost images.

### Apparatus

The disclosed technique may be used in a number of applications. One such application is a 3D conversion device (3D box or device) that can accept multiple 3D formats over a standard video interface. The 3D conversion box implements the above-described technique. For instance, version 1.4 of the HDMI specification defines the following formats: Full resolution Side-by-Side, Half resolution Side-by-Side, Frame alternative (used for Shutter glasses solutions), Field alternative, Left+depth, and Left+depth+Graphics+Graphics depth.

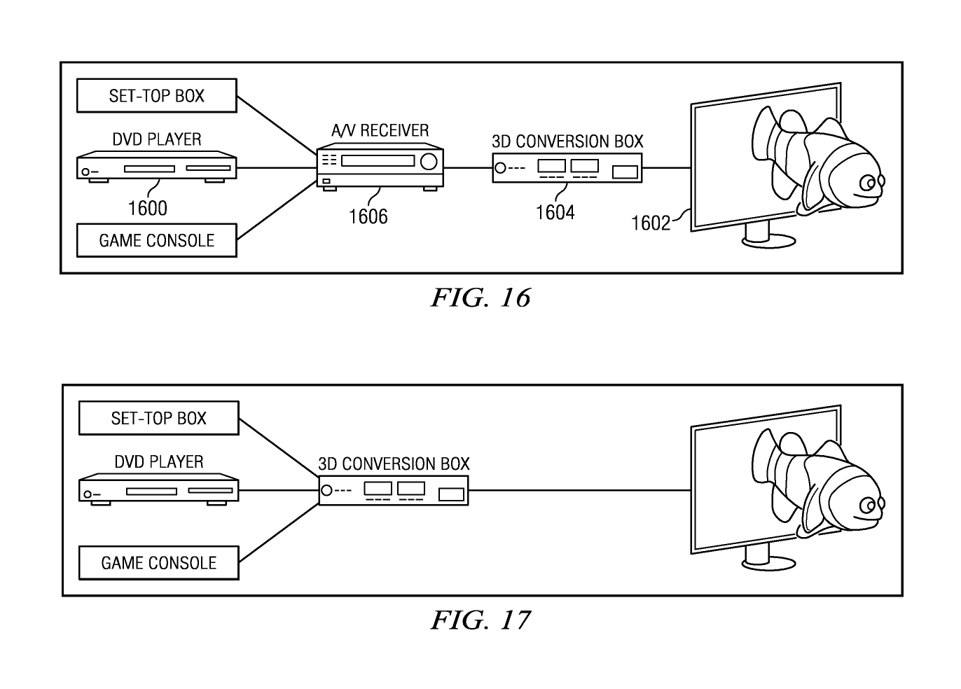

A 3D box may be implemented in two (2) complementary versions, as shown in FIG. 16 and FIG. 17. In one embodiment, the box (or, more generally, device or apparatus) 1604 is installed between an Audio/Video Receiver 1606 and an HD display 1602. As such, the 3D box comes with a pair of HDMI interfaces (Input and Output) that are fully compliant with the recently introduced version 1.4 of the HDMI specification and version 2.0 of the High-bandwidth Digital Content Protection (HDCP) specification. This is illustrated by the conceptual diagram in FIG. 16. As can be seen in FIG. 16, any HD video source 1600 can be shown on an auto-multiscopic display 1602 irrespective of the format of the HD video source. By feeding multiple views (e.g., preferably at least 9, and up to 126) to the auto-multiscopic display, viewers can feel the 3D experience anywhere in front of the display rather than being limited to a very narrow “sweet spot” as was the case with earlier attempts at delivering glasses-free solutions. In an alternative embodiment, such as shown in FIG. 17, one or more various HD Video sources (Set-Top Box, Blu-ray player, Gaming console, etc.) are connected directly to one of the HDMI ports built into the 3D box which in turn connects directly to the HD display. To handle multiple video formats (2D or 3D), preferably the 3D Box also acts as an HDMI hub facilitating its installation without having to make significant changes to the original setup. If desired, the 3D Box 1604 can provide the same results by leveraging the popular DVI (Digital Video Interface) standard instead of the HDMI standard.

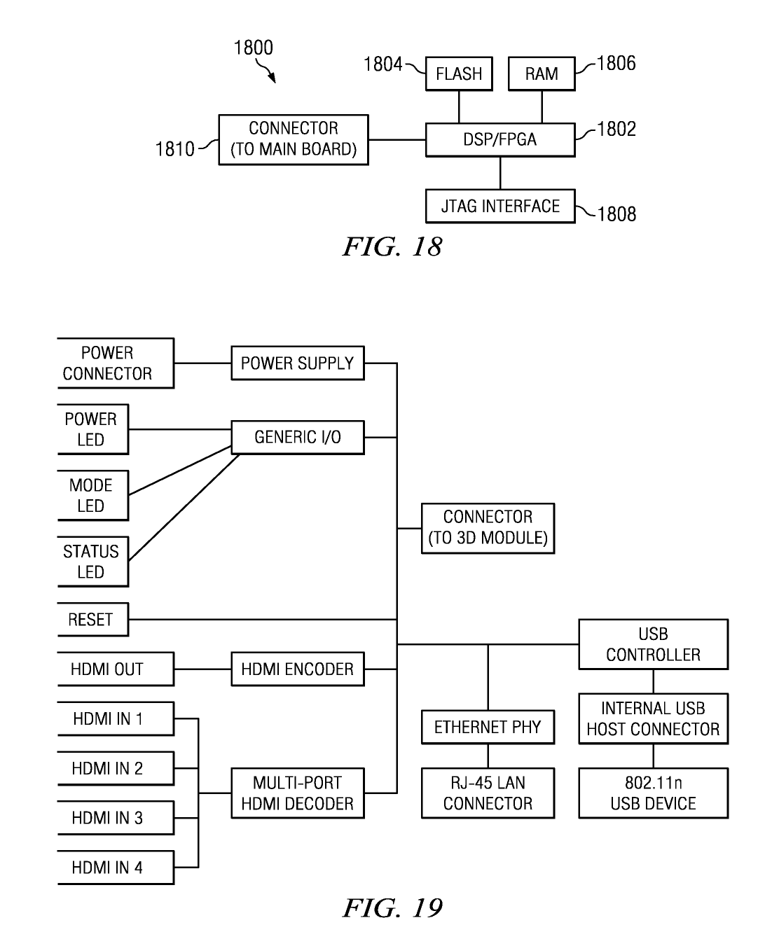

A representative design of a hardware platform required to deliver the above 3D Box is based on the use of a digital signal processor/field-programmable gate array (DSP/FPGA) platform with the required processing capabilities. To allow for the embedding of this capability in a variety of devices including, but not limited to, an auto-multiscopic display, the DSP/FPGA may be assembled as a module 1800 as shown in FIG. 18. The DSP/FPGA 1802 is the core of the 3D module. It executes the 3D algorithms (including, without limitation, the partial disparity and view generator/interweaver) and interfaces to the other elements of the module. Flash memory 1804 hosts a pair of firmware images as well as the necessary configuration data. RAM 1806 stores the 3D algorithms. A JTAG connector 1808 is an interface to facilitate manufacturing and diagnostics. A standard-based connector 1810 connects to the motherboard, which is shown in FIG. 19. Motherboard comprises standard video interfaces and other ancillary functions, which are well-known. An HDMI decoder handles the incoming HD Video content on the selected HDMI port. An HDMI encoder encodes the HD 3D frame to be sent to the display (or other sink device).

As previously noted, the hardware and software systems in which the partial disparity information computation is implemented are merely representative. The inventive functionality may be practiced, typically in software, on one or more machines. Generalizing, a machine typically comprises commodity hardware and software, storage (e.g., disks, disk arrays, and the like) and memory (RAM, ROM, and the like). An apparatus for carrying out the computation comprises a processor, and computer memory holding computer program instructions executed by the processor for carrying out the one or more described operations. The particular machines used in a system of this type are not a limitation. One or more of the above-described functions or operations may be carried out by processing entities that are co-located or remote from one another. A given machine includes network interfaces and software to connect the machine to a network in the usual manner. A machine may be connected or connectable to one or more networks or devices, including display devices. More generally, the above-described functionality is provided using a set of one or more computing-related entities (systems, machines, processes, programs, libraries, functions, or the like) that together facilitate or provide the inventive functionality described above. A representative machine is a network-based data processing system running commodity hardware, an operating system, an application runtime environment, and a set of applications or processes that provide the functionality of a given system or subsystem. As described, the product or service may be implemented in a standalone server, or across a distributed set of machines.

The functionality may be integrated into a camera, an audiovisual player/system, an audio/visual receiver, or any other such system, sub-system or component. As illustrated and described, the functionality (or portions thereof) may be implemented in a standalone device or component.

While the above describes a particular order of operations performed by certain embodiments, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While given components of the system have been described separately, one of ordinary skill will appreciate that some of the functions may be combined or shared in given instructions, program sequences, code portions, and the like.

Having described our invention, what we now claim is set forth below.

1. Apparatus, comprising:
a processor;
computer memory holding program instructions executed by the processor to compute information by the following method:
generating at least one partial disparity list pair from a stereoscopic image pair; and
using the partial disparity list pair to calculate a view position for each sub-pixel of an interweaved image.

2. The apparatus of claim 1 further including a display for displaying the interweaved image.

3. The apparatus as described in claim 2 wherein the display has an associated lenticular lens.

4. The apparatus as described in claim 1 further including an image capture mechanism.

5. The apparatus as described in claim 1 further including an auto-multiscopic display.

6. A system to derive a display image from a stereoscopic pair of left and right images, comprising:
a hardware device including a platform for execution of:
an analyzer functionality that computes partial disparity information that maps a position in a first image and a corresponding position is a second image; and
a generator functionality that uses the partial disparity information to determine an amount of transformation to be applied to each of a set of intermediate views that lie between the left and right images.

7. The system as described in claim 6 further including an interweaving functionality that generates a mapping of each pixel in the display image derived from the stereoscopic pair based on relative positions of the intermediate views that lie between the left and right images.

8. The system as described in claim 6 wherein the partial disparity information comprising a set of disparity line pairs.

9. The system as described in claim 8 wherein the disparity line pairs are generated by:
calculating a sum of differences inside a range of a specified number of pixels on either side of a reference position; and
grouping display coordinates of the reference position to form a list of line segment pairs.

10. A method, comprising:
receiving, from an image capture mechanism, a stereoscopic pair of left and right images;
processing, by a computing entity, the stereoscopic pair to generate partial disparity information, the partial disparity information defining an amount of a transformation to apply to an intermediate view that lies between the left and right images of the stereoscopic pair.

11. The method as described in claim 10 wherein the partial disparity information is a set of partial disparity line pairs.

12. The method as described in claim 11 wherein the transformation is one of: a rotation, a translation, a scaling, and a combination thereof.

13. The method as described in claim 11 wherein the amount of transformation for each pixel in a given intermediate view is a function of a weighted average distance of the pixel and a given point on one or more of the partial disparity lines.

14. The method as described in claim 11 wherein the amount of transformation for each pixel in a given intermediate view is influenced by a weighted average distance of the pixel and a nearest point on all of the partial disparity lines.

15. The method as described in claim 14 wherein the weighted average distance is adjusted by one or more constant values.

16. The method as described in claim 10 wherein the processing is performed in association with a real-time 3D conversion for an auto-stereoscopic display.

17. The method as described in claim 10 wherein the processing is performed in association with a non-real-time 3D conversion for an auto-stereoscopic display.

18. The method as described in claim 10 wherein the intermediate view is one of set of intermediate views that lie between the left and right images of the stereoscopic pair.
